(19) United States
(12) Patent Application Publication
(10) Pub. No.: US 2016/0084288 A1
(43) Pub. Date: Mar. 24, 2016

(54) SELF PIERCING PROJECTION WELDING RIVET, AND JOINED STRUCTURE AND JOINING METHOD USING THE RIVET

(71) Applicant: SUNGWOO HITECH CO., LTD., Busan (KR)

(72) Inventors: Yun Sung CHUNG, Busan (KR); Mun Yong Lee, Busan (KR)

(21) Appl. No.: 14/524,067

(22) Filed: Oct. 27, 2014

(30) Foreign Application Priority Data
Sep. 18, 2014 (KR) 10-2014-0124565

(51) Int. Cl. F16B 19/08; B21J 15/02; B23K 11/11

(52) U.S. Cl. CPC F16B 19/086; B23K 11/115; B21J 15/025

(57) ABSTRACT

A self piercing projection welding rivet is disclosed. According to an exemplary embodiment of the present invention, a self piercing projection welding rivet for joining a non-ferrous material and a steel material may include a head portion, a shank portion integrally connected to the head portion for piercing the non-ferrous material, and a projection portion formed at a piercing end of the shank portion for being brought into contact with the steel material.

### CROSS-REFERENCE TO RELATED APPLICATION

This application claims priority to and the benefit of Korean Patent Application No. 10-2014-0124565 filed in the Korean Intellectual Property Office on Sep. 18, 2014, the entire contents of which are incorporated herein by reference.

### BACKGROUND OF THE INVENTION

(a) Field of the Invention

An exemplary embodiment of the present invention relates to a rivet. More particularly, the present invention relates to a self piercing projection welding rivet for joining different base materials by mechanical joining and fusion bonding, and a joined structure and joining method using the rivet.

(b) Description of the Related Art

In a vehicle industry, in order to improve mileage, weight reduction of a vehicle body is being devised by using non-ferrous materials, such as aluminum alloys, magnesium alloys, and composite materials. For this, the vehicle industry studies joining methods which may replace ordinary spot welding for assembly of a vehicle body.

In this case, the composite material may be, for an example, FRP (Fiber Reinforced Plastic) or CFRP (Carbon Fiber Reinforced Plastic).

In the meantime, though there have been active proceedings of technologies for processing and forming a product of the non-ferrous materials, methods for bonding different materials of the non-ferrous material and steel material have recently been under development.

As a typical method for joining a non-ferrous material and a steel material, a method has been used in which holes are respectively formed in the non-ferrous material and the steel material for riveting, a rivet is placed through the holes, and the rivet placed thus is subjected to plastic deformation to mechanically join the non-ferrous material and the steel material together.

Recently, a method for joining the non-ferrous material and the steel material with the rivet has been introduced, in which the rivet joining hole is form only in the non-ferrous material, and a current and a pressure are applied to the rivet and the steel material in a state in which the rivet is placed in the hole for instantly welding a contact portion of the rivet and the steel material with heat from electric resistance.

However, the related art technology is liable to make productivity and workability poor due to addition of a process for making the rivet joining hole in the non-ferrous material, and it has been difficult to precisely place the rivet in the rivet joining hole in the non-ferrous material at the time of the joining.

Moreover, the making of the rivet joining hole in the non-ferrous material is liable to form fine cracks around a processed portion of the non-ferrous material or to degrade exterior appearance quality of a joined product.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a self piercing projection welding rivet and joined structure and method using the same having advantages of joining different base metals by mechanical joining and fusion bonding.

According to an exemplary embodiment of the present invention, a self piercing projection welding rivet for joining a non-ferrous material and a steel material may include a head portion, a shank portion integrally connected to the head portion for piercing the non-ferrous material, and a projection portion formed at a piercing end of the shank portion for being brought into contact with the steel material.

The projection portion may be melted by a welding current for joining the shank portion to the steel material.

The projection portion may have a triangular cross-section.

The shank portion may have a hollow cylinder shape, with at least one slit formed therein.

The at least one slit may be formed extended from the projection portion toward the head portion spaced at preset intervals in the shank portion.

The shank portion pierces the non-ferrous material by a predetermined pressure, and an edge of the head portion may be press-fitted into a surface of the non-ferrous material by the predetermined pressure.

The head portion may include a flange having a larger diameter than that of the shank portion for holding a surface of the non-ferrous material.

The flange may have a concave surface opposite to the surface of the non-ferrous material.

The flange may have a pointed press-fitted end formed at the edge of thereof to press-fit into the surface of the non-ferrous material.

According to an exemplary embodiment of the present invention, a joined structure using a self piercing projection welding rivet including a head portion, a shank portion integrally connected to the head portion for piercing a first material, and a projection portion formed at a piercing end of the shank portion for being brought into contact with a second material, wherein the shank portion may be press-fitted into the first material and fusion bonded with the second material, may be provided.

In the joined structure, the shank portion may be projection welded to the second material with the projection portion.

In the joined structure, the shank portion may have a hollow cylinder shape with at least one slit formed therein, wherein a portion of the first material inside of the shank portion may be integrally connected to the other portion of the first material matched to the slit.

In the joined structure, the head portion may include a flange having a larger diameter than that of the shank portion for holding a surface of the first material, and an edge of the flange may be press-fitted into the surface of the first material.

In the joined structure, the first material is a non-ferrous material selected from an aluminum alloy, a magnesium alloy, and a composite material.

In the joined structure, the second material may be a steel material.

According to an exemplary embodiment of the present invention, a joining method using a self piercing projection welding rivet including a head portion, a shank portion integrally connected to the head portion for piercing a first material, and a projection portion formed at a piercing end of the shank portion for being brought into contact with a second material, may include the steps of setting a steel material and a non-ferrous material overlapped with each other on a fixed electrode in a state in which a movable electrode is moved to an upper side, feeding the self piercing projection welding rivet to a place under the movable electrode, applying a pressure to the self piercing projection welding rivet with the movable electrode to press-fit the shank portion into the non-ferrous material and to bring the projection portion into contact with the steel material, and applying a welding current to the fixed electrode and the movable electrode for melting the projection portion and fusion bonding the shank portion and the steel material.

In the joining method, the shank portion and the steel material may be welded at the projection portion.

In the joining method, the shank portion may have a hollow cylinder shape with at least one slit formed therein such that a portion of the non-ferrous material inside of the shank portion and the other portion of the non-ferrous material matched to the slit may be integrally connected.

In the joining method, an edge of the head portion may be press-fitted into a surface of the non-ferrous material by a pressure applied by the movable electrode.

In the exemplary embodiment of the present invention, the strong joining of the first and second materials of different base materials without forming a separate joining hole in the first material permits improvement in productivity and workability of a joined product, and enables a reduction in a number of joining steps and production cost.

Further, in an exemplary embodiment of the present invention, since formation of a separate rivet joining hole in the first material is not required, formation of fine cracks around a hole processed portion in the first material does not take place, and exterior appearance quality of a joined product is not harmed.

Moreover, in an exemplary embodiment of the present invention, the reduction of a pierced area in the first material by forming the slits in the shank portion enables a reduction of a joining load of the joining apparatus on the rivet, permitting operation stability of the joining apparatus, and saving the material of the rivet.

In an exemplary embodiment of the present invention, since the shank portion of the rivet, which pierces the first material, is projection welded with the second material at the projection portion, and the flange edge of the head portion is press-fitted into the upper side of the first material with the press-fitted end, joinability and joining strength of the first and second materials can be increased.

In an exemplary embodiment of the present invention, since the portion of the first material inside of the shank portion is integrally connected to the other portion of the first material matched to the slits, the portion of the first material is not sheared completely, but may form an interlock in which the portion is connected to the other portion, enabling the first material to bind to the second material more strongly.

### BRIEF DESCRIPTION OF THE DRAWINGS

The attached drawings illustrate an exemplary embodiment of the present invention, and are provided for describing the present invention in more detail, but not for limiting technical aspects of the present invention.

FIGS. 1 and 2 illustrate perspective views of a self piercing projection welding rivet in accordance with an exemplary embodiment of the present invention, respectively.

FIG. 3 illustrates a sectional view of a self piercing projection welding rivet in accordance with an exemplary embodiment of the present invention.

FIGS. 4 to 6 illustrate schematic views showing the steps of a method for joining different materials with a self piercing projection welding rivet in accordance with an exemplary embodiment of the present invention.

FIG. 7 illustrates a sectional view of a structure of different materials joined with a self piercing projection welding rivet in accordance with an exemplary embodiment of the present invention.

<Description of symbols>

| | | | |
|---|---|---|---|
| 1 | first material | 2 | second material |
| 10 | head portion | 11 | flange |
| 13 | concave surface | 15 | press-fitted end |
| 40 | shank portion | 41 | slit |
| 70 | projection portion | 100 | rivet |
| 101 | movable electrode | 103 | fixed electrode |
| 200 | joining apparatus | 201 | projection welded portion |
| 300 | joined structure | | |

### DETAILED DESCRIPTION OF THE EMBODIMENTS

The present invention will be described more fully hereinafter with reference to the accompanying drawings, in which an exemplary embodiment of the invention is shown such that persons skilled in this field of art may easily carry it out. As those skilled in the art would realize, the described embodiment may be modified in various different ways, all without departing from the spirit or scope of the present invention.

Parts not relevant to the present invention will be omitted for describing the present invention clearly, and throughout the specification, identical or similar parts will be given the same reference numbers.

Since sizes and thicknesses of elements are shown at will for convenience of description, the present invention is not limited to the drawings without fail, but the thicknesses are enlarged for clearly expressing different parts and regions.

Although terms including ordinal numbers, such as first or second, can be used for describing various elements in the detailed description of the present invention, the elements are not confined by the terms, and are used only for making one element distinct from other elements.

Throughout the specification, unless explicitly described to the contrary, the word “comprise” and variations such as “comprises” or “comprising” will be understood to imply the inclusion of stated elements but not the exclusion of any other elements.

Terms such as “ . . . Unit”, “ . . . Means”, etc., mean a unit of an element having at least one function or operation.

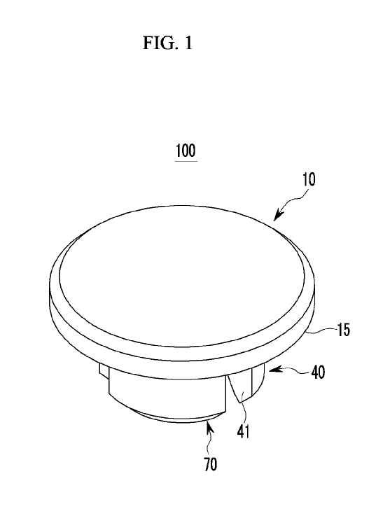

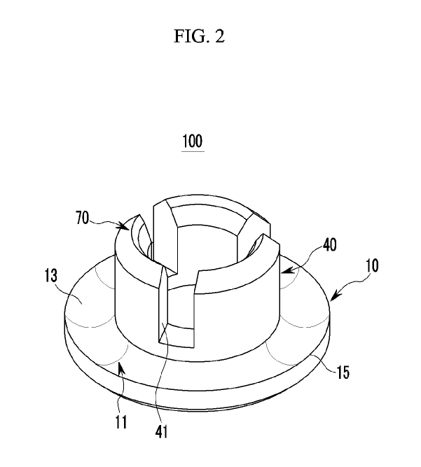

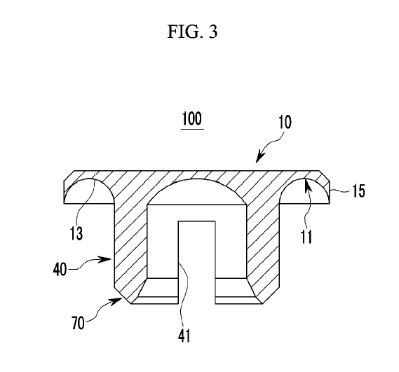

FIGS. 1 and 2 illustrate perspective views of a self piercing projection welding rivet in accordance with an exemplary embodiment of the present invention, respectively, and FIG. 3 illustrates a sectional view of a self piercing projection welding rivet in accordance with an exemplary embodiment of the present invention.

Referring to FIGS. 1 to 3, the self piercing projection welding rivet 100 may be applied to a vehicle body assembly process for joining two sheets of base materials overlapped with each other, for an example, vehicle panels, as one unit. However, the base materials are not limited to the vehicle panels always, but may also include different vehicle body structures, such as vehicle members and frames.

Moreover, it is required to understand that the scope of the present invention is not always limited to the assembly of the vehicle body, but if it is a structure of different kinds and purposes fabricated by predetermined components, the technical aspects of the present invention are applicable.

The self piercing projection welding rivet 100 in accordance with an exemplary embodiment of the present invention is for joining two different base materials by mechanical joining and fusion bonding.

Hereafter, for better comprehension and ease of description, when the self piercing projection welding rivet 100 is seen while it is set upright, a portion facing upward will be called ‘top portion’, ‘upper side’, or a term similar to these, and a portion facing downward will be called ‘bottom portion’, ‘lower side’, or a term similar to these.

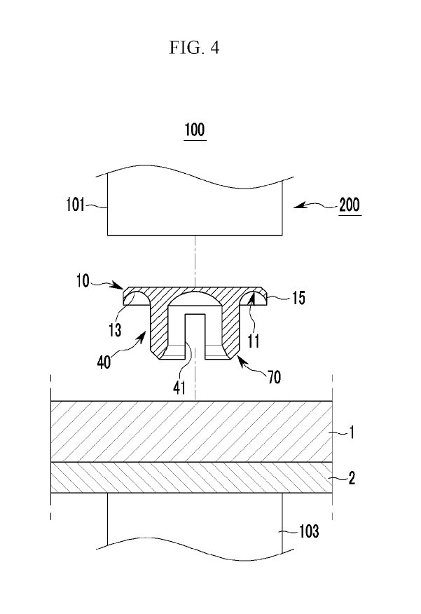

With reference to the drawings, of the two sheets of the base materials, it may be defined that the base material positioned on an upper side will be called a first material 1 (see FIG. 4), and the base material positioned on a lower side will be called a second material 2 (see FIG. 4).

The above definition of direction has a relative meaning, and since the direction may vary with a reference position of the self piercing projection welding rivet 100 and a joining direction of the first and second materials 1 and 2, the reference direction is not always limited to a reference direction of the present exemplary embodiment.

In this case, the first and second materials 1 and 2 are different materials, wherein the first material 1 may be a non-ferrous material including an aluminum alloy, a magnesium alloy, and a composite material (for example, FRP, CFRP, plastic, rubber, and so on). The second material 2 may be a steel material.

That is, the second material 2 is provided as a base sheet, and the first material 1 may be provided as a cover sheet overlapped with the upper surface of the second material 2 without forming a rivet joining hole therein like the related art.

The exemplary embodiment of the present invention includes a joining apparatus 200 (hereafter see FIG. 4) for joining the first and second base materials with the self piercing projection welding rivet 100 by mechanical joining and fusion bonding.

The joining apparatus 200 has a structure which may apply a welding current both to the self piercing projection welding rivet 100 and the second material 2 while applying a predetermined pressure to the self piercing projection welding rivet 100.

The joining apparatus 200 will be described in more detail with reference to FIGS. 4 to 6.

The self piercing projection welding rivet 100 in accordance with an exemplary embodiment of the present invention to be described hereafter has a structure which pierces the first material 1 of a non-ferrous material and fusion bonds with the second material of the steel material by projection welding for joining the first and second materials 1 and 2 by mechanical joining and fusion bonding.

For this, the self piercing projection welding rivet 100 in accordance with an exemplary embodiment of the present invention includes a head portion 10, a shank portion 40, and a projection portion 70.

In an exemplary embodiment of the present invention, the head portion 10 is a portion having the pressure applied thereto from the joining apparatus 200 described above for holding an upper surface of the first material 1.

The head portion 10 is provided to the upper side of the rivet 100, and has a circular plate shape with a predetermined thickness.

In an exemplary embodiment of the present invention, the shank portion 40 is a portion which pierces the first material 1 owing to the pressure applied to the head portion 10 by the joining apparatus 200 for piercing through the first material 1 and being press-fitted therein.

The shank portion 40 is integrally connected to an underside of the head portion 10, and has a hollow cylinder shape.

The shank portion 40 has at least one slit 41 formed therein. The slit 41 is formed for reducing a pierced area in the first material 1 by the shank portion 40.

The slit 41 extends from a piercing end of the shank portion 40, i.e., from the projection portion 70 to be further described later, toward the head portion 10.

For example, there are three slits 41 formed in a circumferential direction around an inside center of the shank portion 40 spaced at 120° intervals.

The number and the intervals of the slits in the shank portion 40 are not always limited to three and 120°, but may vary with strength of the first material 1 and joining strength of the rivet 100.

Not only the shank portion 40, but also an edge portion of the head portion 10 may be press-fitted to the upper surface of the first material 1 by the pressure applied thereto from the joining apparatus 200.

For this, the head portion 10 has a larger outside diameter than an outside diameter of the shank portion 40, and includes a flange 11 for holding the upper surface of the first material 1.

In this case, the flange 11 has a concave surface 13 opposite to the upper surface of the first material 1 that is curved starting from an end of the shank portion 40 to an edge of the flange 11.

The flange 11 has a pointed press-fitted end 15 formed at the edge thereof to press-fit into the upper surface of the first material 1.

In an exemplary embodiment of the present invention, the projection portion 70 is projected from a piercing end portion of the shank portion 40 so as to be brought into contact with the upper surface of the second material 2 in a state in which the shank portion 40 pierces, and is press-fitted into, the first material 1.

The projection portion 70 is melted by the welding current applied from the joining apparatus 200 to the rivet 100 and the second material 2, to serve as a welding projection for fusion bonding the shank portion 40 to the second material 2.

The projection portion 70 is formed projecting from a piercing end portion of the shank portion 40 to have a triangular cross-section except for the slit 41.

Hereafter, a method for joining materials by using the self piercing projection welding rivet 100 in accordance with an exemplary embodiment of the present invention will be described in detail with reference to the drawings disclosed before and accompanying drawings.

FIGS. 4 to 6 illustrate schematic views showing the steps of a method for joining different materials with a self piercing projection welding rivet in accordance with an exemplary embodiment of the present invention.

Referring to FIGS. 4 to 6, in an exemplary embodiment of the present invention, first and second materials 1 and 2 may be joined by using the joining apparatus 200 described above with the self piercing projection welding rivet 100 (“rivet” hereinafter) by mechanical joining and fusion bonding.

The joining apparatus 200 includes a movable electrode 101 mounted to be movable in up/down directions, a fixed electrode 103 mounted to be fixedly secured under the movable electrode 101, and a rivet feeder (not shown) for feeding the rivet 100 to the fixed electrode 103.

The movable electrode 101 may be an anodic welding electrode mounted to a predetermined frame to be movable in up/down directions either hydraulically or pneumatically. The movable electrode 101 may apply a pressure and an anodic welding current to the rivet 100 as the movable electrode 101 moves downward.

Further, the fixed electrode 103 may be a cathodic welding electrode mounted to be fixedly secured to a frame opposite to the movable electrode 101. The fixed electrode 103 supports the first and second materials 1 and 2 that are overlapped with each other, wherein the fixed electrode 103 supports the second material 2 and the first material 1 upward in succession for applying the cathodic welding current to the second material 2.

Since the joining apparatus 200 is an element of a projection welding system known to persons in this field of art, more detailed description of the joining apparatus 200 will be omitted from this specification.

An example will be described in which the first and second materials 1 and 2 are joined by using the joining apparatus 200. In an exemplary embodiment of the present invention, as shown in FIG. 4, in a state in which the movable electrode 101 is moved to an upper side, the first and second materials 1 and 2 that are overlapped with each other are set on the fixed electrode 103.

Then, in an exemplary embodiment of the present invention, the rivet 100 is fed to a place under the movable electrode 101, i.e., to a preset joining portion of the first and second materials 1 and 2 by using the rivet feeder (not shown).

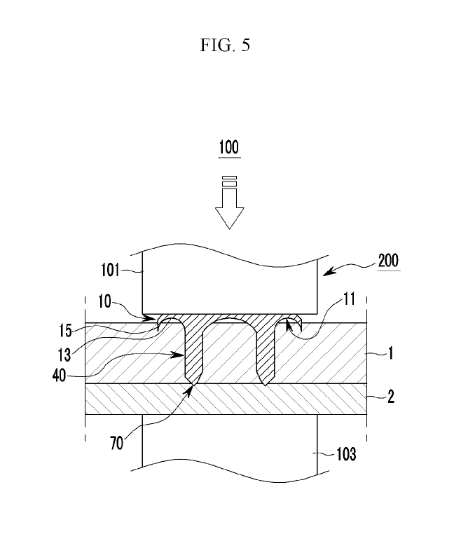

In this state, as shown in FIG. 5, the movable electrode 101 is moved downward to apply a pressure to the head portion 10 of the rivet 100 through the movable electrode 101.

Then, the shank portion 40 of the rivet 100 pierces and is press-fitted into the first material 1 such that the projection portion 70 formed at the piercing end portion of the shank portion 40 is brought into contact with the upper surface of the second material 2.

In this case, in an exemplary embodiment of the present invention, since the shank portion 40 has the slits 41 formed therein, a pierced area of the first material 1 by the shank portion 40 may be reduced, and a portion of the first material 1 inside of the shank portion 40 may be integrally connected to the other portion of the first material 1 matched to the slit 41.

In this process, the head portion 10 holds the upper surface of the first material 1 with the flange 11, wherein the press-fitted end 15 of the edge of the flange 11 may be press-fitted into the upper surface of the first material 1.

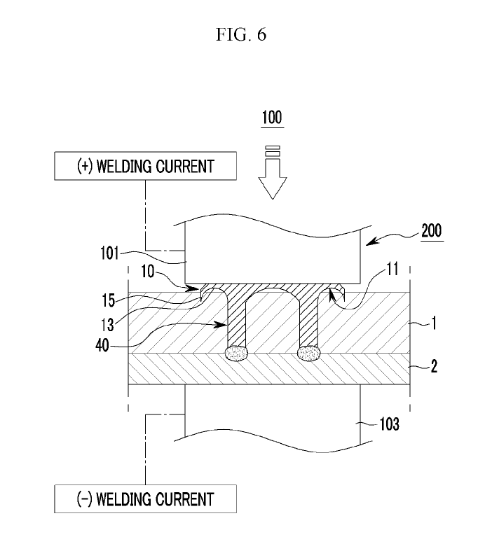

Thus, the shank portion 40 of the rivet 100 is press-fitted into the first material 1 at a predetermined pressure, and in a state in which the projection portion 70 is brought into contact with the upper surface of the second material 2, in an exemplary embodiment of the present invention as shown in FIG. 6, the welding current is applied to the movable electrode 101 and the fixed electrode 103.

Then, in an exemplary embodiment of the present invention, the projection portion 70 is heated and melted by heat from electrical resistance as the current and the pressure are concentrated on the projection portion 70. Accordingly, in an exemplary embodiment of the present invention, a contact area of the projection portion 70 forms a weld nugget to fusion bond the shank portion 40 and the second material 2.

That is, in an exemplary embodiment of the present invention, in a state in which the first and second materials 1 and 2 are supported by the fixed electrode 103 and the rivet 100 is pressed by the movable electrode 101, if the welding current is applied to the movable electrode 101 and the fixed electrode 103, the projection portion 70 is melted instantly, to projection weld the shank portion 40 and the second material 2.

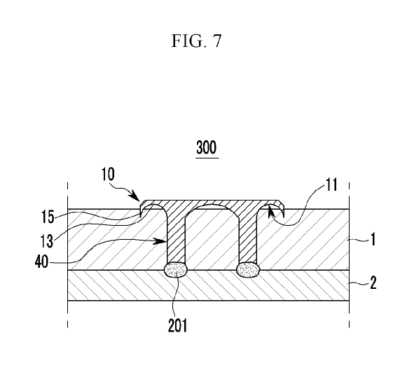

Finally, if the welding current being applied to the movable electrode 101 and the fixed electrode 103 is cut off and the movable electrode 101 is moved upward, assembly of a joined structure 300 is finished, in which the first and second materials 1 and 2 are integrally joined with the rivet 100 by mechanical joining and fusion bonding (see FIG. 7).

FIG. 7 illustrates a sectional view of a structure of different materials joined by using a self piercing projection welding rivet in accordance with an exemplary embodiment of the present invention.

Referring to FIG. 7, the joined structure 300 that is joined by using the self piercing projection welding rivet 100 in accordance with an exemplary embodiment of the present invention may have the shank portion 40 of the rivet 100 press-fitted into the first material 1 of the non-ferrous material, and fusion bonded with the second material of the steel material.

That is, alike the joining process described above, the shank portion 40 is projection welded to the second material 2 with the projection portion 70 by the heat from electrical resistance to integrally connect the shank portion 40 and the second material 2 with a projection welded portion 201.

In this case, the head portion 10 of the rivet 100 holds the upper surface of the first material 1 with the flange 11, and the edge of the flange 11 press-fitted into the upper surface of the first material 1 with the press-fitted end 15.

Further, in an exemplary embodiment of the present invention, the slits 41 formed in the shank portion 40 of the rivet 100 make a portion of the first material 1 inside of the shank portion 40 integrally connected to the other portion of the first material 1 matched to the slits 41.

Accordingly, in an exemplary embodiment of the present invention, since the shank portion 40 of the rivet 100 which pierces the first material 1 is projection welded with the second material 2 at the projection portion 70, and the flange edge of the head portion 10 is press-fitted into the upper surface of the first material 1 with the press-fitted end 15, joinability and joining strength of the first and second materials 1 and 2 can be increased.

In an exemplary embodiment of the present invention, since the portion of the first material 1 inside of the shank portion 40 is integrally connected to the other portion of the first material 1 matched to the slits 41, the portion of the first material 1 is not sheared completely, but may form an interlock in which the portion is connected to the other portion. Accordingly, in an exemplary embodiment of the present invention, the first material 1 can bind the second material 2 more strongly.

According to the self piercing projection welding rivet 100, and the joined structure 300 and method using the same in accordance with the exemplary embodiment of the present invention, strong joining of the first and second materials 1 and 2 of different base materials without forming a separate joining hole in the first material 1 permits an improvement in productivity and workability of a joined product, and enables a reduction of a number of joining steps and production cost.

In an exemplary embodiment of the present invention, since formation of a separate rivet joining hole in the first material 1 is not required, formation of fine cracks around a hole processed portion in the first material 1 does not take place, so exterior appearance quality of a joined product will not be harmed.

Moreover, in an exemplary embodiment of the present invention, the reduction of a pierced area in the first material 1 by forming the slits 41 in the shank portion 40 enables a reduction of a joining load of the joining apparatus 200 on the rivet 100, increasing operation stability of the joining apparatus 200, and saving the material of the rivet 100.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A self piercing projection welding rivet for joining a non-ferrous material and a steel material, comprising:
a head portion;
a shank portion integrally connected to the head portion for piercing the non-ferrous material; and
a projection portion formed at a piercing end of the shank portion for being brought into contact with the steel material.

2. The rivet of claim 1, wherein the projection portion is melted by a welding current for joining the shank portion to the steel material.

3. The rivet of claim 1, wherein the projection portion has a triangular cross-section.

4. The rivet of claim 1, wherein the shank portion has a hollow cylinder shape, with at least one slit formed therein.

5. The rivet of claim 4, wherein the at least one slit is formed extended from the projection portion toward the head portion spaced at preset intervals in the shank portion.

6. The rivet of claim 1, wherein the shank portion pierces the non-ferrous material by a predetermined pressure, and an edge of the head portion is press-fitted into a surface of the non-ferrous material by the predetermined pressure.

7. The rivet of claim 1, wherein the head portion includes a flange having a larger diameter than that of the shank portion for holding a surface of the non-ferrous material.

8. The rivet of claim 7, wherein the flange has a concave surface opposite to the surface of the non-ferrous material.

9. The rivet of claim 8, wherein the flange has a pointed press-fitted end at the edge thereof to press-fit into the surface of the non-ferrous material.

10. A joined structure using a self piercing projection welding rivet including a head portion, a shank portion integrally connected to the head portion for piercing a first material, and a projection portion formed at a piercing end of the shank portion for being brought into contact with a second material, wherein the shank portion is press-fitted into the first material and fusion bonded with the second material.

11. The joined structure of claim 10, wherein the shank portion is projection welded to the second material with the projection portion.

12. The joined structure of claim 10, wherein the shank portion has a hollow cylinder shape with at least one slit formed therein, wherein a portion of the first material inside of the shank portion is integrally connected to the other portion of the first material matched to the slit.

13. The joined structure of claim 10, wherein the head portion includes
a flange having a larger diameter than that of the shank portion for holding a surface of the first material, and
an edge of the flange is press-fitted into the surface of the first material.

14. The joined structure of claim 10, wherein the first material is a non-ferrous material selected from an aluminum alloy, a magnesium alloy, and a composite material.

15. The joined structure of claim 14, wherein the second material is a steel material.

16. A joining method using a self piercing projection welding rivet including a head portion, a shank portion integrally connected to the head portion for piercing a first material, and a projection portion formed at a piercing end of the shank portion for being brought into contact with a second material, comprising the steps of:
setting a steel material and a non-ferrous material overlapped with each other on a fixed electrode in a state in which a movable electrode is moved to an upper side;
feeding the self piercing projection welding rivet to a place under the movable electrode;
applying a pressure to the self piercing projection welding rivet with the movable electrode to press-fit the shank portion into the non-ferrous material and to bring the projection portion into contact with the steel material; and
applying a welding current to the fixed electrode and the movable electrode for melting the projection portion and fusion bonding the shank portion and the steel material.

17. The joining method of claim 16, wherein the shank portion and the steel material are welded at the projection portion.

18. The joining method of claim 16, wherein the shank portion has a hollow cylinder shape with at least one slit formed therein such that a portion of the non-ferrous material inside of the shank portion and the other portion of the non-ferrous material matched to the slit are integrally connected.

19. The joining method of claim 16, wherein an edge of the head portion is press-fitted into a surface of the non-ferrous material by a pressure applied by the movable electrode.
